(19) United States
(12) Patent Application Publication
(10) Pub. No.: US 2004/0052505 A1
(43) Pub. Date: Mar. 18, 2004

(54) Summarization of a visual recording

(75) Inventors: Subutai Ahmad, Palo Alto, CA (US); Harold G. Sampson, Sunnyvale, CA (US); Jonathan R. Cohen, San Francisco, CA (US)

Correspondence Address: David R. Graham, 1337 Chewpon Avenue, Milpitas, CA, 95035, US

(73) Assignee: YesVideo, Inc.

(21) Appl. No.: 10/448,255

(22) Filed: May 28, 2003

Related U.S. Application Data
(60) Provisional application No. 60/383,821, filed on May 28, 2002.

(51) Int. Cl. H04N 5/783

(52) U.S. Cl. 386/69; 386/83

(57) ABSTRACT

The invention facilitates and/or enhances the creation and/or viewing of a summary of a visual recording. The invention can be implemented so that part or all of the creation of a visual recording summary is performed automatically, thus increasing the ease and speed with which a visual recording summary can be created. The invention can also be implemented so that clips (segments of the visual recording) of high quality and/or particular interest are selected for inclusion in a visual recording summary. Additionally, the invention can be implemented to enable synchronization of non-source audio content, such as music, to the display of clips of the visual recording summary.

### BACKGROUND OF THE INVENTION

1. Field of the Invention

This invention relates to viewing of a visual recording. In particular, this invention relates to facilitating viewing of a visual recording and, most particularly, to creation of a summary of a visual recording.

2. Related Art

There are a large number of products aimed at helping people interact with (e.g., view, digitize, edit, organize, share) their home video (or other multimedia content) using a personal computer (e.g., desktop computer, laptop computer). However, those computer-based products are typically very labor intensive and require a significant amount of time to manipulate the video into the desired final form.

For example, one common way in which people desire to interact with home video is to select desirable segments of a video recording and create a new video recording that is shorter in duration than the original video recording, i.e., create a summary of an original video recording. This may be done, for instance, to produce a “highlights” video recording that includes segments of the original video recording that are of particular interest. Sometimes audio content (such as music) is combined with the video recording summary to make viewing of the video recording summary more enjoyable. However, existing computer-based products for facilitating the creation of a video recording summary do not enable automatic creation of a high quality video recording summary, thus making creation of a video recording summary require time and effort than is desirable.

### SUMMARY OF THE INVENTION

The invention can facilitate and/or enhance the creation and/or viewing of a summary of a visual recording. In particular, the invention can advantageously be implemented so that part or all of the creation of a visual recording summary in accordance with the invention is performed automatically, thus increasing the ease and speed with which a visual recording summary can be created. The invention can also be implemented so that clips (segments of the visual recording) of high quality and/or particular interest are selected for inclusion in a visual recording summary. Additionally, the invention can be implemented to enable synchronization (and, of particular advantage, automatic synchronization) of non-source audio content (i.e., audio content that is not part of the audio content, if any, of the original visual recording), such as music, to the display of clips of the visual recording summary (in particular, synchronization to transitions between clips of the visual recording summary), thus producing a visual recording summary having a professional look and feel.

In one embodiment of the invention, a visual recording summary is created by evaluating the visual recording data of the visual recording and selecting one or more segments of the visual recording (which together comprise less than all of the visual recording) to be included in the visual recording summary based on the evaluation of the visual recording data. The quality, content and/or position of visual images of the visual recording can be evaluated and the evaluation used to select segments for inclusion in the visual recording summary. In a particular embodiment, scenes are identified in the visual recording and one or more scenes selected for inclusion in the visual recording summary. In another particular embodiment, candidate visual images are identified in the visual recording and segments of the visual recording that have a specified relationship to one or more candidate visual images that are determined to be of sufficient interest in accordance with a specified criterion or criteria are selected for inclusion in the visual recording summary. An evaluation of audio content to be included as part of the visual recording summary can also be used in selecting segments of the visual recording for inclusion in the visual recording summary. The creation of a visual recording summary in accordance with this embodiment of the invention can advantageously be performed, at least in part, automatically.

In another embodiment of the invention, a segment of a visual recording is selected by: 1) evaluating the quality, content and/or position in the visual recording of each of multiplicity of visual images of the visual recording; 2) selecting one or more visual images from the visual recording based on the evaluations of the multiplicity of visual images; and 3) identifying a segment of the visual recording that has a specified relationship to the one or more selected visual images. Multiple segments of a visual recording can be selected in this way. The selection of segments of the visual recording in accordance with this embodiment of the invention can advantageously be performed, at least in part, automatically.

In yet another embodiment of the invention, a visual recording summary is created by selecting one or more segments of the visual recording (which together comprise less than all of the visual recording) to be included in the visual recording summary and associating non-source audio content with the selected segment(s), the selection of segment(s) and/or the association of non-source audio content being performed, at least in part, automatically.

In still another embodiment of the invention, viewing of a visual recording is facilitated by selecting one or more segments of the visual recording for viewing as a first summary of the visual recording, and selecting one or more segments of the visual recording for viewing as a second summary of the visual recording, such that a majority of the segments in the first summary of the visual recording are not in the second summary of the visual recording. In a more particular embodiment, none of the segments in the first summary of the visual recording is the same as a segment in the second summary of the visual recording. The facilitation of viewing of a visual recording in accordance with this embodiment of the invention can advantageously be performed, at least in part, automatically.

In another embodiment of the invention, a visual recording summary is created by selecting one or more segments of a first visual recording to be included in the visual recording summary and selecting one or more segments of a second visual recording to be included in the visual recording summary. The first and second visual recordings can be of the same event or object, and can be acquired at the same or approximately the same time, but be acquired using different visual recording apparatus and/or from different perspectives. The creation of a visual recording summary in accordance with this embodiment of the invention can advantageously be performed, at least in part, automatically.

In yet another embodiment of the invention, viewing of a visual recording is facilitated by selecting one or more segments of the visual recording to be included in the visual recording summary, and including one or more still visual images in the visual recording summary. The facilitation of viewing of a visual recording in accordance with this embodiment of the invention can advantageously be performed, at least in part, automatically.

In still another embodiment of the invention, a portable computer readable medium or media stores both instructions and/or data representing a visual recording and instructions and/or data representing a summary of the visual recording. The portable computer readable medium or media can be, for example, one or more DVDs or one or more optical disks. The portable computer readable medium or media can also store instructions and/or data representing non-source audio content.

### BRIEF DESCRIPTION OF THE DRAWINGS

FIG. 1 is a block diagram illustrating components of a system in which the invention can be used.

FIG. 2 is a flow chart of a method, according to an embodiment of the invention, for creating a summary of a visual recording.

FIG. 3 is a flow chart of a method, according to another embodiment of the invention, for creating a summary of a visual recording.

FIG. 4 is a flow chart of a method, according to yet another embodiment of the invention, for creating a summary of a visual recording.

### DETAILED DESCRIPTION OF THE INVENTION

It can be desirable to create a summary of a visual recording for a variety of reasons. (Herein, a “visual recording” includes a series of visual images acquired at a regular interval by a visual data acquisition apparatus such as a video camera and representing visual content that occurs over a period of time. A visual recording may or may not also include audio content.) For instance, it may be desired to create a visual recording summary including only segments of the original, full-length visual recording that are deemed to be of particular interest, i.e., create a “highlights” visual recording. (A segment of a visual recording is sometimes referred to herein as a “clip.”) It may also be desired to eliminate segments of the original visual recording that are deemed to be of undesirably low quality, e.g., segments including blurriness, aliasing effects, poor contrast, poor exposure and/or little or no content (e.g., blank images). In general, creation of a summary of a visual recording can facilitate viewing of the content represented by the visual recording.

The invention can facilitate and/or enhance the creation and/or viewing of a summary of a visual recording. In particular, the invention can be implemented to make use of the advent of digital media and automated video processing techniques to enable creation of a visual recording summary faster and easier than has previously been possible. The invention can advantageously be implemented so that part or all of the creation of a visual recording summary in accordance with the invention (e.g., ascertaining audio content characteristic(s), ascertaining visual image characteristic(s), ascertaining the duration of the visual recording summary, selecting segments of the visual recording for inclusion in the visual recording summary, determining the duration of segments of the visual recording summary, specifying the order of display of segments in the visual recording summary, specifying the type of transition between segments of the visual recording summary) is performed automatically, thus increasing the ease and speed with which a visual recording summary can be created. The invention can also be implemented so that clips of high quality and/or particular interest are selected for inclusion in a visual recording summary. Additionally, the invention can be implemented to enable synchronization (arid, of particular advantage, automatic synchronization) of non-source audio content (i.e., audio content that is not part of the audio content, if any, of the original visual recording), such as music, to the display of clips of the visual recording summary (in particular, synchronization to transitions between clips of the visual recording summary), thus producing a visual recording summary having a professional look and feel.

The invention can make use of, and can extend, systems, apparatus, methods and/or computer programs described in the following commonly owned, co-pending U.S. patent applications: 1) U.S. patent application Ser. No. 09/792,280, entitled “Video Processing System Including Advanced Scene Break Detection Methods for Fades, Dissolves and Flashes,” filed on Feb. 23, 2001, by Michele Covell et al.; 2) U.S. patent application Ser. No. 10/198,602, entitled “Automatic Selection of a Visual Image or Images from a Collection of Visual Images, Based on an Evaluation of the Quality of the Visual Images,” filed on Jul. 17, 2002, by Michele Covell et al.; and 3) U.S. patent application Ser. No. 10/226,668, entitled “Creation of Slideshow Based on Characteristic of Audio Content Used to Produce Accompanying Audio Display,” filed on Aug. 21, 2002, by Subutai Ahmad et al. The disclosures of each of those applications are hereby incorporated by reference herein. Particular ways in which aspects of the inventions described in those applications can be used with the invention of the instant application are identified below.

According to one aspect of the invention, a visual recording summary can be created based on an evaluation of the visual recording data of a visual recording. According to another aspect of the invention, a clip for inclusion in a visual recording summary can be selected based on an evaluation of the quality, content and/or position in the visual recording of the visual images of a visual recording. According to yet another aspect of the invention, a visual recording summary that is at least partly created automatically can include audio content that is not part of the audio content, if any, of the original visual recording. According to still another aspect of the invention, multiple non-overlapping visual recording summaries (i.e., visual recording summaries that do not snare any visual images from the original visual recording) can be produced from a single, original visual recording. According to another aspect of the invention, a visual recording summary can be created from multiple original visual recordings. According to yet another aspect of the invention, a visual recording summary can include one or more still images in addition to segment(s) from a visual recording. According to still another aspect of the invention, a visual recording summary can be stored together with the original visual recording on the same data storage medium or media.

The invention can make use of two types of data to enable creation of a visual recording summary: content data (e.g., visual recording data, still visual image data, audio data) and metadata. Herein, “metadata” is used as known in the art to refer to data that represents information about the content data. Examples of metadata and ways in which metadata can be used in the invention are described in more detail below. Metadata can be created manually (e.g., specification by the creator of a set of content data of a title for, or a description of, the set of content data). Metadata can also be extracted automatically from a set of content data (e.g., automatic evaluation of the quality of a visual image, automatic determination of scene breaks and/or keyframes in a visual recording, automatic identification of beats in music).

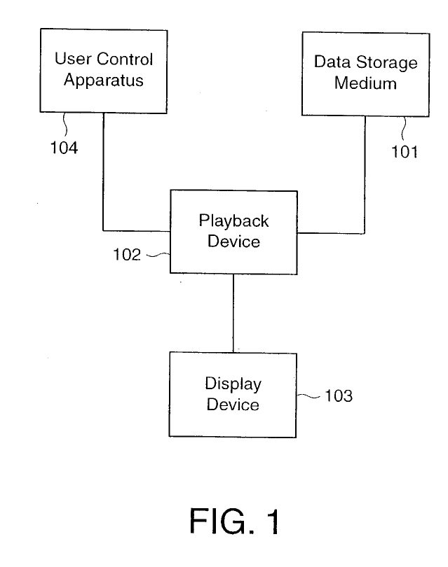

FIG. 1 is a block diagram illustrating components of a system in which the invention can be used. The components of the system illustrated in FIG. 1 can be embodied by any appropriate apparatus, as will be understood by those skilled in the art in view of the description herein. Content data is stored on data storage medium 101. The content data can include visual image data and/or audio data. Metadata can also be stored on the data storage medium 101. The data storage medium 101 can be embodied by any data storage apparatus. For example, the data storage medium 101 can be embodied by a portable data storage medium or media, such as one or more DVDs, one or more CDs, one or more videotapes, or one or more optical disks. The data storage medium 101 can also be embodied by data storage apparatus that are not portable (in addition to, or instead of, portable data storage medium or media), such as a hard drive (hard disk) or digital memory, which can be part of, for example, a desktop computer or personal video recorder (PVR). Further, the content data can be stored on the data storage medium 101 in any manner (e.g., in any format). A playback device 102 causes content data (some or all of which, as indicated above, can be stored on the data storage medium 101) to be used to produce a visual or audiovisual display on a display device 103. When some or all of the content data is stored on a portable data storage medium or media, the playback device 102 is constructed so that a portable data storage medium can be inserted into the playback device 102. The playback device 102 can be embodied by, for example, a conventional DVD player, CD player, combination DVD/CD player, or computer including a CD and/or DVD drive. The playback device 102 can have included or associated therewith data recording apparatus for causing data to be stored on a portable data storage medium (e.g., a CD or DVD “burner” for storing content data representing a visual recording summary on a CD or DVD). The display device 103 can be embodied by, for example, a television or a computer display monitor or screen. A user control apparatus 104 is used to control operation of the playback device 102 and visual display device 103. The user control apparatus 104 can be embodied by, for example, a remote control device (e.g., a conventional remote control device used to control a DVD player, CD player or combination DVD/CD player), control buttons on the playback device 102 and/or visual display device 103, or a mouse (or other pointing device). As described in more detail elsewhere herein, the user control apparatus 104 and/or the playback device 102 (or processing device(s) associated therewith) can also be used to cause a visual recording summary according to the invention to be created. A system according to the invention for creating a visual recording summary can be implemented using the data processing, data storage and user interface capabilities of the components of the system of FIG. 1, as can be appreciated in view of the description herein.

The invention can advantageously be used, for example, with a home theater system. A home theater system typically includes a television and a digital video playback device, such as a DVD player or a digital PVR. A PVR (such as a Tivo™ or Replay™ device) typically contains a hard drive, video inputs and video encoding capabilities. The digital video playback device can be enhanced with software that reads metadata encoded on a digital data storage medium, which can be useful with some embodiments of the invention, as discussed elsewhere herein. The digital video playback device can also include data storage apparatus for storing one or more computer programs for creating a visual recording summary in accordance with the invention. The digital video playback device can include or have associated therewith a DVD or CD burner which can be used for storing data representing a visual recording summary after the summary has been created. The digital video playback device (or other apparatus of the home theater system) can also contain a network connection to the Internet or a local area network (LAN).

Although the invention can advantageously be used with a home theater system, the invention is not limited to use with that platform. A visual recording summary according to the invention can be created and/or displayed on any hardware platform that contains the appropriate devices. For example, the invention can be used with a personal computer, which often includes a video input (e.g., direct video input or a DVD drive), as well as a processor, a hard drive and a display device, and has associated therewith a DVD or CD burner.

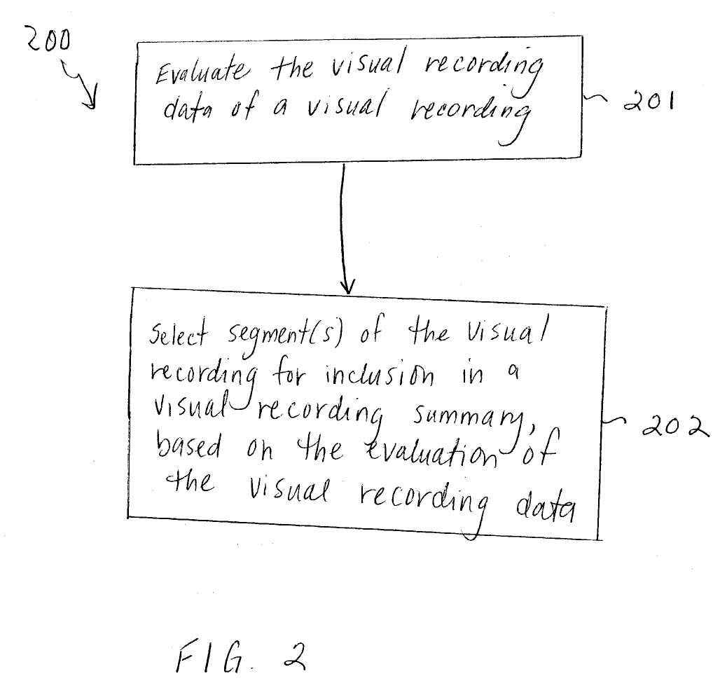

FIG. 2 is a flow chart of a method 200, according to an embodiment of the invention, for creating a summary of a visual recording. In step 201, the visual recording data of the visual recording is evaluated. In particular, the visual image data of the visual recording can be evaluated. The evaluation of the visual recording data can produce metadata regarding the visual recording, e.g., visual image metadata, as discussed in more detail below. However, other metadata (e.g., title and/or description of the visual recording) may be pre-existing and can be ascertained as part of the evaluation of step 201. In step 202, one or more segments (clips) of the visual recording are selected for inclusion in a summary of the visual recording, based on the evaluation of the visual recording data. The selected clip(s) comprise less than all of the visual recording, i.e., the selected clip(s) constitute a summary of the visual recording. The selection of clip(s) can be based on metadata produced in step 201. In particular, the selection of clip(s) can be based on visual image metadata, as discussed in more detail below. The method 200 can advantageously be implemented so that the creation of the visual recording summary is performed automatically, entirely or in part. For example, some or all of the method 200 can be automatically performed by operation of a computational device in accordance with appropriate computer program(s).

In a particular embodiment of the method 200, the visual recording data of a visual recording is evaluated to identify scenes in the visual recording (step 201) and one or more of the scenes is selected for inclusion in the visual recording summary (step 202). The evaluation of the visual recording data can produce information regarding the scenes, such as the location of the scenes in the visual recording. The evaluation of the visual recording data can also produce other information regarding the scenes, such as identification of a visual image (“keyframe”) in each scene that is representative of that scene. When keyframes are identified, the evaluation of the visual recording data can also produce information regarding the keyframes (e.g., the quality, content and/or position in the visual recording of the keyframes). The selection of scenes for inclusion in the visual recording summary can be accomplished in a variety of ways, depending on the nature of the evaluation of the visual recording, as discussed in more detail below.

A scene can be identified in a visual recording by locating “scene breaks” in the visual recording, a segment of the visual recording between scene breaks (or between a scene break and the beginning or the end of the visual recording) constituting a “scene.” A “scene” is a visual recording segment including visual images that represent related content; a “scene break” is a location in a visual recording at which one scene ends and another scene begins. The location of scene breaks and scenes in a visual recording can be identified using any of a variety of methods. For example, scene breaks and scenes can be identified using a method as described in the above-referenced U.S. patent application Ser. No. 09/792,280.

The selection of scenes for inclusion in a visual recording summary can be based on the location of the scene in the visual recording. For example, a scene can be selected based on a specified relationship to one or more other scenes in the visual recording or a scene can be selected based on a specified temporal relationship to the visual recording. For instance, scenes can be selected at regular intervals, i.e., every nth scene, for inclusion in the visual recording summary. Or, for instance, scenes can be selected for inclusion in the visual recording summary according to a more complicated algorithm regarding the order of occurrence of the scenes in the visual recording (as can be readily appreciated, the possibilities are too numerous to discuss), which may, for example, favor inclusion of scenes occurring at a particular part of the visual recording, such as near the beginning and/or near the end of the visual recording. Or, for instance, scenes that occur at particular times (e.g., a specified duration of time from the beginning or end of the visual recording) or at a specified percentage of the way through the visual recording can be selected for inclusion in the visual recording summary.

Scenes can also be selected for inclusion in the visual recording summary by identifying a keyframe (i.e., a visual image that is deemed to be representative of a segment of a visual recording) for each scene and selecting scenes for inclusion in the visual recording summary based on an evaluation of the keyframes. A keyframe for a scene (or any other segment of a visual recording) can be identified using any of a variety of methods. For example, a visual image can be identified as a keyframe or not based on the location of the visual image in the corresponding scene. For instance, a visual image can be identified as a keyframe or not based on a specified relationship of the visual image to one or more other visual images in the scene (e.g., a keyframe is specified to be the nth visual image from the beginning or end of a scene, such as the first or last visual image of a scene) or based on a specified temporal relationship of the visual image to the scene (e.g., a keyframe is the visual image that occurs a specified duration of time from the beginning or end of a scene). A keyframe can also be identified by evaluating the content of a scene and choosing as the keyframe a visual image of the scene that is determined to be, based on the evaluation, representative of the content of the scene. For example, keyframes can be identified using a method as described in the above-referenced U.S. patent application Ser. No. 09/792,280, or as described in the above-referenced U.S. patent application Ser. No. 10/198,602. Keyframes can be evaluated in a variety of ways to determine which of the corresponding scenes are to be included in the visual recording summary. For example, the quality, content and/or position in the visual recording of the keyframes can be evaluated to identify keyframes of particular interest. (Evaluation of the quality, content and/or position in the visual recording of a visual image is described in more detail below.) Keyframes can also be compared to identify redundancy, it being desirable to minimize redundancy among keyframes (as a proxy for minimizing redundancy among scenes selected for inclusion in the visual recording summary). A score can be produced for each keyframe based on one or more characteristics of the keyframe (e.g., the characteristics described above). When the score is based on multiple characteristics, the contribution to the score of each characteristic can be weighted to increase or decrease the influence of particular characteristics on the score. Scenes including a keyframe that is determined to be of sufficient interest in accordance with a specified criterion or criteria can be included in the visual recording summary (e.g., with a sufficiently high score, either absolutely or relative to other keyframes). Techniques used in the above-referenced U.S. patent application Ser. Nos. 10/198,602 and 10/226,668 for evaluating a visual image and scoring a visual image based on one or more evaluations of the visual image can be used with the instant invention to evaluate and score keyframes (or other visual images); however, in evaluating and scoring a visual image in an embodiment of the instant invention, evaluation of the quality need not necessarily, but can be, done.

The invention can be implemented so that a scene is included in a visual recording summary if the scene meets a specified criterion or criteria. The specified criterion or criteria can be established based on the scene characteristics discussed above (e.g., location of the scene in the visual recording, evaluation of the scene's keyframe). The invention can also be implemented so that a score is determined for each scene and scenes included in a visual recording summary based on the scores. The score can be based on the scene characteristics discussed above, which can be weighted differently so that different scene characteristics have different amounts of influence on the score. In particular, the score for a scene can depend, in whole or in part, on a score determined for the keyframe of that scene.

In another particular embodiment of the method 200, the visual recording data of a visual recording is evaluated to identify visual images of interest in the visual recording (step 201) and segments (clips) of the visual recording that have a specified relationship to one or more visual images that are determined to be of sufficient interest in accordance with a specified criterion or criteria are selected for inclusion in the visual recording summary (step 202). An identified visual image of interest (step 201) is sometimes referred to herein as a “candidate visual image,” a visual image determined to be of sufficient interest (step 202) is sometimes referred to herein as a “selected visual image,” and a clip having a specified relationship to one or more selected visual images is sometimes referred to herein as a “selected clip.” This particular embodiment of the method 200 can be implemented as an extension of embodiments of the invention described in the above-referenced U.S. patent application Ser. No. 10/226,668 in which visual images are selected from a collection of visual images (the collection of visual images can be a visual recording) and displayed in a series as a slideshow. In the instant invention, instead of displaying visual images selected from a visual recording as a series of still visual images, the selected visual images can be used as indices into the visual recording to effect display of clips from the visual recording that correspond to (e.g., include) the selected visual images.

The candidate visual images and selected visual images can be identified using any of a variety of methods, examples of which are described in more detail below. The selected visual images can be identified using the same method or methods used to identify candidate visual images, a method or methods different from the method or methods used to identify candidate visual images, or a combination of a method or methods that are the same as the method or methods used to identify candidate visual images and a method or methods that are different from the method or methods used to identify candidate visual images. The selected visual images can be a subset of the candidate visual images (i.e., include less than all of the candidate visual images) or the selected visual images can be the same as the candidate visual images (i.e., include all of the candidate visual images).

A candidate visual image or a selected visual image can be identified based on a specified relationship to one or more other candidate visual images or one or more other selected visual images, respectively. For instance, candidate visual images or selected visual images can be identified at regular intervals, i.e., every nth scene. Or, for instance, candidate visual images or selected visual images can be identified according to a more complicated algorithm regarding the order of occurrence of visual images in the visual recording (as can be readily appreciated, the possibilities are too numerous to discuss), which may, for example, favor identification of visual images occurring at a particular part of the visual recording, such as near the beginning and/or near the end of the visual recording. A candidate visual image or a selected visual image can also be identified based on a specified temporal relationship of the visual image to the visual recording. For instance, a candidate visual image or a selected visual image can be identified as a visual image that occurs at a particular time during the visual recording (e.g., a specified duration of time from the beginning or end of the visual recording) or that occurs at a particular percentage of the way through the visual recording.

A candidate visual image or selected visual image can also be identified based on an evaluation of the visual images of a visual recording. For example, one or more of the quality (i.e., the presence or absence of defects in the visual image, such as, for example, blurriness, aliasing, high contrast, bad exposure and absence of content), content (i.e., subject matter) and/or position in the visual recording of a visual image can be evaluated to identify a candidate visual image or selected visual image. Further, each of the quality, content and/or position in the visual recording of a visual image can be evaluated using one or more types of such evaluation (exemplary types of quality, content and position evaluation are described below). For example, the quality of a visual image can be evaluated using one or more of an image variation evaluation (which evaluates the amount of variation within a visual image), an image structure evaluation (which evaluates the amount of smoothness within a visual image), an inter-image continuity evaluation (which evaluates the degree of similarity between a visual image and the immediately previous visual image in a chronological sequence of visual images), an edge sharpness evaluation (which evaluates the amount of “edginess,” i.e., the presence of sharp spatial edges, within a visual image), and an image luminance evaluation (which evaluates the amount of energy within a visual image). The content of a visual image can be evaluated, for example, using one or more of a face detection evaluation (which evaluates whether or not a visual image includes a recognizably human face and may also identify aspects of the face, such as the size of the face, whether or not both eyes are visible and open, and/or the visibility and curvature of the mouth), a flesh detection evaluation (which evaluates whether or not a visual image includes flesh), a mobile object evaluation (which evaluates whether or not a visual image includes an object, e.g., person, animal, car, that is, was, or will be moving relative to another object pr objects, e.g., the ground, in the visual image), and a camera movement evaluation (which evaluates whether or not a change occurred in the field of view of a visual data acquisition apparatus between the time of acquisition of a visual image currently being evaluated and the immediately previous visual image, or over a specified range of temporally contiguous visual images including the visual image currently being evaluated). The position in a visual recording of a visual image can be evaluated, for example, using one or more of a potential keyframe evaluation (which evaluates whether a visual image is near the start of a defined segment, e.g., a shot or scene, of a visual recording) and a transitional image evaluation (which evaluates whether a visual image occurs during a gradual shot change, e.g., a dissolve). Each of the above-described types of quality, content and position evaluation is described in detail in the above-referenced U.S. patent application Ser. No. 10/198,602. Other evaluations of a visual image can also be used. For example, if scene break information has also been determined for the visual recording, whether or not a visual image is a keyframe can determine or influence whether the visual image is identified as a candidate visual image or a selected visual image. Additionally, prospective candidate visual images or selected visual images can be compared to identify redundancy, it being desirable to minimize redundancy among candidate visual images or selected visual images (as a proxy for minimizing redundancy among clips selected for inclusion in the visual recording summary). Any of the methods of evaluating a visual image described in U.S. patent application Ser. No. 10/198,602 can be used with the instant invention to evaluate a visual image. Further, as can be readily appreciated by those skilled in the art, other methods similar to those described in U.S. patent application Ser. No. 10/198,602 can be used with the instant invention to evaluate a visual image. For example, in embodiments of the instant invention, when evaluating a visual image the quality of the visual image need not necessarily, but can be, evaluated. As indicated above, any combination of the above-described types of quality, content and position evaluation can be used to evaluate a visual image in embodiments of the instant invention.

Each of the visual images of a visual recording can be assigned a score representing the results of the evaluation of that visual image. The score can be established based on any of the types of evaluation described above, as well as any combination of such evaluations. When a combination of evaluations is used, the evaluations can be weighted to increase or decrease the influence of particular evaluations on the score. The score for a visual image indicates the desirability of the visual image as a candidate visual image or selected visual image; typically, the scores are established such that the score for a visual image increases as the desirability of the visual image as a candidate visual image or selected visual image increases. The scores can be used to determine which visual images are identified as candidate visual images and which visual images are identified as selected visual images: visual images having a sufficiently high score, either absolutely or relative to other visual images, can be identified as candidate visual images or selected visual images. For example, the number of candidate visual images and selected visual images can be pre-established (e.g., by user specification or as a parameter of a method used to implement the invention). Candidate visual images and selected visual images can be identified as the specified number of visual images having the highest scores. Determination of scores for visual images and use of scores to identify visual images as candidate visual images or selected visual images can be performed using methods described in, or that are similar to methods described in (as can be readily appreciated by those skilled in the art), the above-referenced U.S. patent application Ser. Nos. 10/198,602 and 10/226,668 for evaluating and scoring visual images; however, it should be noted that in evaluating and scoring a visual image in an embodiment of the instant invention, evaluation of the quality need not necessarily, but can be, done.

As indicated above, in this particular embodiment of the method 200, clips of the visual recording that have a specified relationship to one or more selected visual images are selected for inclusion in the visual recording summary. It is anticipated that this embodiment of the invention will often be implemented so that a clip is selected (i.e., the range of visual images of the clip specified) such that the clip includes a single selected visual image. For example, a clip can be selected so that a selected visual image is located at a particular location within the clip, e.g., at or near the center of the clip, at or near the beginning of the clip, at or near the end of the clip. A clip can also be selected so that a selected visual image is not included as part of the clip, but so that the clip has a specified location in the visual recording relative to the location of the selected visual image. A clip can also be selected so that the clip has a specified relationship to multiple selected visual images. For example, a clip can be selected so that the clip includes each of multiple selected visual images. Such a clip may be specified so that the multiple selected visual images are located at particular locations within the clip, e.g., the clip is specified so that one of two selected visual images is a specified duration of time or number of visual images from the start of the clip and the other of the two selected visual images is a specified duration of time or number of visual images from the end of the clip.

Selection of a clip also entails specifying the duration of the clip. The duration of a clip can be established directly as a specified duration of time or specified number of visual images. The duration of a clip can also be established by specifying one or more durations of time or numbers of visual images relative to a selected visual image included in the clip, e.g., a clip can include a first specified duration of time or specified number of visual images before a single selected visual image to which the clip is related and a second specified duration of time or specified number of visual images (which can be the same as the first specified duration of time or specified number of visual images) after the selected visual image. The duration of a clip can also be the duration of the scene including a single selected visual image to which the clip is related, i.e., the clip is the scene that includes the selected visual image. The duration of a clip can also be established in accordance with audio content that is included as part of the visual recording summary. For example, when music is included as part of a visual recording summary, the duration of each clip can be established in accordance with the occurrence of beats, measures and/or phrases in the music. For instance, the duration of each clip can be the interval (sometimes referred to herein as a “beat interval”) between two specified beats (e.g., two major beats), which interval can vary throughout a visual recording summary. A typical beat interval is between about 3 seconds to about 7 seconds, though other beat intervals can be used in embodiments of the invention. The duration of a clip can also be a multiple of a beat interval or a sum of successive beat intervals.

If scene break information has also been determined for the visual recording, the scene break information can be used in identifying candidate visual images, identifying selected visual images, or selecting a clip. For example, a clip can be selected so that the clip has a specified relationship to a scene break, e.g., the beginning or end of the clip is within a specified duration of time or number of visual images of a scene break. Or, for example, identification of a visual image as a candidate visual image or a selected visual image can depend on the proximity of the visual image to a scene break or a specified type of scene break.

Selection of a clip based on the relationship of the clip to one or more selected visual images, as described above, will typically result in a clip that is not coincident with a scene of the visual recording. Such a clip can be subsumed within a scene, can subsume one or more scenes (including part of an additional scene or parts of two additional scenes), or can include parts of two adjacent scenes. In the latter two cases, a clip spans adjacent scenes, i.e., the clip traverses a scene break. Viewing of a scene break may be deemed jarring to a viewer (producing a flashing effect) and therefore undesirable. Thus, it can be desirable, to the extent possible, to inhibit clips of a visual recording summary from spanning two adjacent scenes. If scene break information has been determined for the visual recording, embodiments of the invention in which a clip does not necessarily coincide with a scene can be implemented so that each clip is evaluated to determine whether the clip includes a scene break. Such embodiments of the invention can be implemented so that if the clip does not include a scene break the clip is not adjusted, but if the clip does include a scene break the clip is adjusted so that the clip begins at or after the scene break, or ends before or at the scene break, thereby ensuring that the clip does not traverse the scene break. If a clip includes multiple scene breaks (i.e., the clip subsumes one or more scenes), such embodiments of the invention can be implemented so that the clip is adjusted so that the beginning or end of the clip coincides with one of the scene breaks, thus minimizing the number of scene transitions in the clip.

Audio content can be included as part of a visual recording summary according to the invention. Audio content included as part of a visual recording summary can be sound that is part of the original visual recording (sometimes referred to herein as “source audio content”) or audio content that is not part of the original visual recording (sometimes referred to herein as “non-source audio content”). Any type of audio content can be included as part of a visual recording summary according to the invention. In particular, non-source music can be included as part of the visual recording summary. When non-source music is included as part of the visual recording summary, the invention can be implemented to synchronize the music with the display of the clips of the visual recording summary, as discussed in more detail below. Spoken narrative is another type of nor-source audio content that can be included as part of a visual recording summary according to the invention. As with music, the display of clips of a visual recording summary can be correlated to characteristics of spoken narrative, such as pauses or changes in subject matter.

Metadata regarding a visual recording can be used to select non-source audio content for use in a visual recording summary. For example, visual recording metadata such as the title or a description of a visual recording (e.g., a description that indicates a visual recording is of a funeral or a party) can be used to make a determination regarding the mood of the visual recording. As discussed further below, music can be evaluated to determine the mood of the music. Based on a determination of the moods of various pieces of music (as indicated by evaluation of the music), an appropriate piece of music can be chosen to accompany a visual recording that matches the mood of the visual recording (e.g., upbeat music can be chosen for a summary of a visual recording of a party, somber music can be chosen for a summary of a visual recording of a funeral). Similarly, the tempo of various pieces of music can be determined by evaluating the music and an appropriate piece of music chosen to match the “tempo” of a visual recording (which can be indicated by the amount of motion in the visual recording, determined as discussed elsewhere herein).

As indicated above, source audio content can be included as part of the visual recording summary. When source audio content is included as part of the visual recording summary, alignment between the visual image data and audio data of the visual recording can be used to select source audio content for inclusion as part of the visual recording summary that corresponds to the clips of the visual recording that are included as part of the visual recording summary. The invention can be implemented so that only source audio content is included as part of the visual recording summary. The invention can also be implemented so that both non-source and source audio content are included as part of the visual recording summary. For example, the invention can be implemented so that non-source audio content (e.g., music) and source audio content are blended together (e.g., the respective volumes of the non-source audio content and source audio content are controlled in a desired manner) in the visual recording summary. The non-source music and source audio content can be blended together so that the music is heard as background to the source audio content and/or so that only the non-source music or the source audio content are heard at any particular time. As an enhancement to such an implementation of the invention, the source audio content can be evaluated using appropriate audio content detectors, as known to those skilled in the art, to identify the presence of voices, silence or other types of sound in the source audio content, and the blending of the music and source audio content dynamically adjusted to enhance the music or source audio content in accordance with the type of sound occurring in the source audio content. For example, the blending of the music and source audio content can be dynamically adjusted to, at any given time, include only the music or source audio content, or emphasize one of the music or source audio content relative to the other, so that the most interesting audio content is presented or emphasized, or to create an emotional effect, much as a movie sound editor would. For instance, when speech occurs, the speech can be emphasized or displayed alone. The invention can advantageously be implemented so that the blending of the music and source audio content occurs automatically.

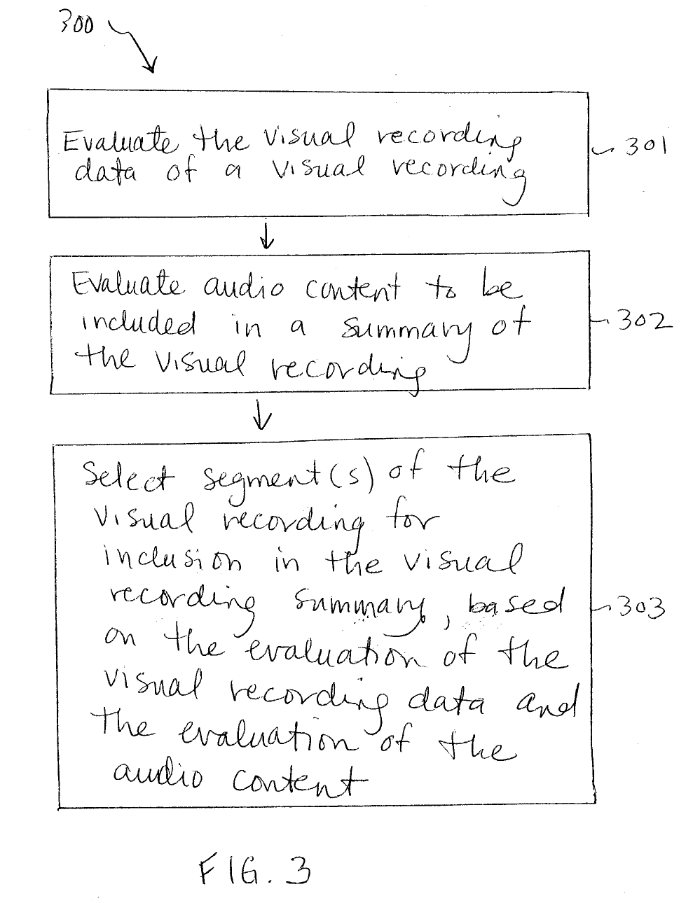

Audio content that is to be included in a visual recording summary can also be evaluated and the evaluation used in selecting segments for inclusion in the visual recording summary. FIG. 3 is a flow chart of a method 300, according to another embodiment of the invention, for creating a summary of a visual recording. In step 301, the visual recording data of the visual recording is evaluated. The step 301 can be implemented in the same manner as the step 201 of the method 200, described above. In step 302, audio content (e.g., music) to be included in the summary is evaluated. The audio content can be either source audio content or non-source audio content. In step 303, one or more segments (clips) of the visual recording are selected for inclusion in the visual recording summary, based on the evaluation of the visual recording data and the evaluation of the audio content. The selected clip(s) of the visual recording comprise less than all of the visual recording, i.e., the selected clip(s) of the visual recording constitute a summary of the visual recording. Like the method 200, the method 300 can advantageously be implemented so that the creation of the visual recording summary is performed automatically, entirely or in part, e.g., some or all of the method 300 can be automatically performed by operation of a computational device in accordance with appropriate computer program(s).

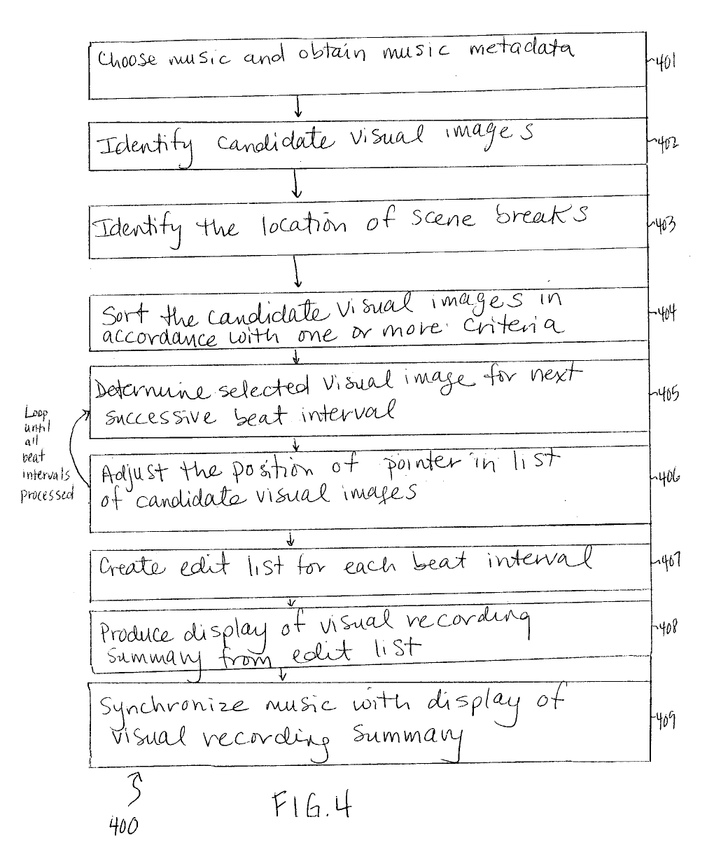

As indicated above, when non-source music is included as part of a visual recording summary, the invention can be implemented to synchronize the music with the display of the clips of the visual recording summary. This can be done by evaluating the music and using the evaluation of the music in selecting the clips. In particular, the evaluation of the music can be used to establish or affect the duration of one or more clips. For example, the music can be evaluated, as discussed in more detail below, to identify the occurrence of beats, measures and/or phrases in the music. The duration of the clips of the visual recording summary can be established so that the occurrence of beats (e.g., major beats), measures and/or phrases in the music is related to transitions from the display of one clip to another. For example, the duration of the clips of the visual recording summary can be established so that each transition between clips coincides with a specified beat in the music (e.g., each major beat in the music) or so that the duration of a clip includes multiple beat intervals (e.g., corresponds to a measure or phrase). In such case, one or more other beats may or may not occur during each clip. Conversely, the duration of the clips of the visual recording summary can be established so that each specified beat in the music coincides with a transition between clips. In such case, one or more transitions between clips may or may not occur between the specified beats. A particular way of using beats in music to affect the duration of clips of a visual recording summary is described in detail below with respect to the method 400 of FIG. 4. Situations in which it is necessary or desirable to establish minimum or maximum clip durations, as well as ways of enforcing minimum and maximum clip durations, are also discussed below with respect to the method 400 of FIG. 4.

Evaluation of other types of audio content can also affect the selection of clips: in particular, the evaluation can be used to establish or affect the duration of one or more clips. For example, a spoken narrative can be evaluated, as discussed in more detail below, to identify the occurrence of pauses and/or subject matter changes in the narrative. The duration of the clips of a visual recording summary can be established so that the occurrence of a pause or subject matter change in a spoken narrative that accompanies the visual recording summary is related to (e.g., coincides with) a transition from the display of one clip to another.

After clips are selected for inclusion in a visual recording summary, a display order for the clips can be established. The clips can be displayed in chronological order. The clips can also be displayed in the order in which the clips were selected for inclusion in the visual recording summary. The clips can also be displayed in an order based on score(s) for selected visual image(s) to which the clips are related, e.g., clips can be displayed in order of increasing or decreasing score.

A visual recording summary has a duration that is shorter than that of the visual recording from which the summary is produced. The duration of a visual recording summary can be specified directly as a particular duration of time (for example, by a user or by a service for providing visual recording summaries). The duration of a visual recording summary can also be specified as a percentage of the duration of a visual recording. The duration of a visual recording summary can also be established in other ways. For example, the duration of a visual recording summary can be established in accordance with the duration of non-source audio content that is to be included as part of the visual recording summary, e.g., music that is to accompany the visual recording summary. For instance, the duration of a visual recording summary can be established as the duration of the non-source audio content or a multiple of that duration.

A visual recording summary can be displayed multiple times. This may be desirable, for example, when non-source audio content (e.g., music) that is to be included as part of the visual recording summary is longer than the duration of the visual recording summary: the visual recording summary can be displayed repeatedly until the conclusion of the non-source audio content (e.g., music). Further, in such case, a further summary of the visual recording summary can be produced (e.g., in accordance with the principles for producing a visual recording summary as described herein) and used in subsequent displays after the first display of the visual recording summary. This approach can be used, for example, to produce a summary of the summary “finale” to match the end of a piece of music. Additionally, multiple visual recording summaries can each be displayed one or more times during the display of particular audio content. (Multiple visual recording summaries can be created from a single visual recording, as discussed further below, or from multiple visual recordings.) The invention can also be implemented so that a visual recording summary display includes any combination of the above.

To enhance the display of the visual recording summary, the invention can be implemented to produce particular effects at the end of the display. For example, audio content that is included as part of the visual recording summary can be faded to silence as the end of the display approaches. This can be desirable, for example, if the duration of the audio content is longer than that of the visual recording summary. Similarly, the visual images of the visual recording summary can be faded out or faded to a specified color (e.g., black) as the end of the display approaches. This can be desirable, for example, if the duration of the visual recording summary is longer than that of the audio content. Additionally, the invention can be implemented so that both the audio content and the visual images are faded out (or the visual images faded to a specified color) as the end of a display of a visual recording summary approaches.

In a visual recording summary, a transition occurs between each pair of adjacent clips of the visual recording summary. (In embodiments of the invention in which a visual recording summary also includes one or more still visual images, as discussed below, a transition also occurs between a clip and a still visual image; the discussion below of transitions between clips applies as well to transitions between a clip and still visual image.) The invention can be implemented to enable use of any type of transition between clips, a large variety of which are known to those skilled in the art of editing visual recordings. Conventional transition generators can be used to produce transitions of a desired type. The invention can be implemented to make use of the same type of transition throughout a visual recording summary or the invention can be implemented to make use of multiple types of transitions in a visual recording summary. The invention can also be implemented to evaluate the visual recording summary and use transitions in accordance with the evaluation: in the extreme case, the invention can be implemented to evaluate which type of transition to use for each pair clips in the visual recording summary. The simplest transition between a pair of clips is a cut; the invention can be implemented so that a cut is the default transition type. However, a cut may be deemed most appropriate for transitions that occur in the vicinity of fast beats (i.e., short beat intervals). A visual recording summary can be enhanced by using other types of transitions (e.g., cross fades, dissolves, wipes, shutters) that are particularly appropriate for particular beat frequencies or that produce particular effects, e.g., to adjust the mood and feel of the visual recording summary. For example, a cross fade is a common transition used by professional editors that can be used in implementing the invention. A cross fade can be suitable for use in, for example, a visual recording summary that is to be accompanied by a relatively slow piece of music. The invention can be implemented, for example, to use cross fades randomly throughout a visual recording summary or to use a cross fade for a transition that occurs when the duration of beats that occur near the transition is above a specified level (or, conversely, when the beat frequency at the location of the transition is below a specified level). Similarly, a dissolve can be used for transitions that occur in the vicinity of slow beats (i.e., long beat intervals).

As discussed above, the invention can make use of two types of data to enable creation of a visual recording summary: content data (e.g., visual recording data, still visual image data, audio data) and metadata (i.e., data representing information about the content data). As discussed further below, the content data can take a variety of forms and be provided for use by a visual recording summary creation system according to the invention in a variety of ways. The metadata can be provided to a visual recording summary creation system according to the invention (having been produced before operation of that system to create a visual recording summary) or the metadata can be produced by a visual recording summary creation system according to the invention.

The invention can be used to facilitate and/or enhance the creation and/or viewing of a visual recording summary produced from any type of visual recording. As used herein, a “visual recording” includes visual image content data and may or may not also include audio content data. Visual recordings with which the invention can be used can be stored on any type of data storage medium or media, e.g., analog or digital videotape, 8 mm film (such as Super 8 mm film), reel-to-reel tape.

The invention creates a visual recording summary using digital content data. Digital content data (e.g., digital visual recording data or digital still visual image data) can be obtained directly using a digital data acquisition device, such as a digital still or video camera. For example, a user can acquire a visual recording directly in digital form by recording on to miniDV tape, optical disk or a hard drive. Digital content data can also be produced by converting analog content data obtained using an analog data acquisition device, such as an analog still or video camera, to digital content data using techniques known to those skilled in the art. For example, a user can digitize analog content data and store the digitized content data on one or more digital data storage media such as DVD(s), CD-ROM(s) or a hard drive. A user can do this using existing software program(s) on a conventional computer. There also exist cost-effective services, such as provided by, for example, YesVideo, Inc. of Santa Clara, Calif., for digitizing analog visual recording or still visual image data and storing the digitized data on a digital data storage medium, e.g., one or more portable data storage media such as one or more DVDs or CDs.

During or after acquisition or digitization of visual image content data (visual recording data or still visual image data), metadata can be produced regarding the visual image content data. Visual image metadata can be produced before creation of a visual recording summary. In that case, the metadata can be stored on a portable data storage medium or media (e.g., one or more DVDs or CDs) together with visual image content data. The metadata can be stored in a standard data format (e.g., in one or more XML files). Visual image metadata can also be produced during creation of a visual recording summary. As indicated above, visual image metadata can be created manually (e.g., by being specified by a creator of visual image content data or by a user or operator performing processing, such as digitization, of the visual image content data) or automatically (e.g., by performing computer analysis of visual image content data). Visual image metadata that is typically created manually can include, for example, data representing a title for, a description of, and the name of a creator (e.g., a person or entity who acquired, or caused to be acquired, content data) of a visual recording or a collection of still visual images. Visual image metadata that is typically created automatically (but can also be created manually) can include, for example, data representing the number of visual images in a visual recording or a collection of still visual images, the locations of visual images within a visual recording or collection of still visual images, the date of acquisition (capture) of a visual recording or a collection of still visual images, the date of digitization of analog visual content data, data regarding one or more characteristics of a visual image (e.g., image sharpness or other image quality characteristic, colors in an image, motion in an image, the presence of a facial expression in an image, etc.), scores for visual images, and data identifying the location of scene breaks and/or keyframes in a visual recording. In one embodiment of the invention, visual image metadata is stored in XML format on a portable data storage medium or media (e.g., one or more DVDs or CDs) together with a visual recording during the capture or digitization process and includes at least data representing the title, description and/or date of capture of the visual recording, and frame indices corresponding to the visual images of the visual recording determined to be representative of clips to be included in a summary of the visual recording.

As discussed in more detail above, audio content data can be used in creation of a visual recording summary according to the invention and/or as part of a visual recording summary according to the invention. The invention can make use of any type of audio content data for those purposes, such as, for example, audio data representing music, spoken narrative and/or sound that is part of the visual recording to be summarized.

Audio metadata can be determined by evaluating the audio content data. Determination of audio metadata can be performed automatically or manually; however, it can be advantageous to determine audio metadata automatically. Further, audio metadata can be determined prior to creation of a visual recording summary or during creation of a visual recording summary.

When the audio content includes music (entirely or in part), the music can be evaluated to identify beats, phrases and/or measures in the music. (As discussed above, the display of clips in the visual recording summary can be controlled in accordance with the occurrence of beats in music.) The identification of beats in music can be accomplished in a variety of ways, as known to those skilled in the art. Qualitatively, beats are identified as how a person would “tap to” the music. The identification of beats can be done manually, before or during creation of a visual recording summary, by a person listening to the music and tapping out the beats. The identification of beats can also be done automatically by one or more computer programs that analyze the music and identify beats, either before creation of the visual recording summary or at the time of creation of the visual recording summary. This can be done using known automated beat detection methods, such as, for example, a method as described in “Tempo and beat analysis of acoustic musical signals, by Eric D. Scheirer, J. Acoust. Soc. Am. 103(1), January 1998 (the “Scheirer paper”), the disclosure of which is incorporated by reference herein. Different types of beats can be identified, e.g., some beats can be classified as major beats (which can be specified as a beat that begins a measure), while other beats are classified as minor beats; the type of beat can be determined by, for example, identifying the strength of the beat. Groups of beats—measures, phrases—can also be identified. Each beat can be represented as a temporal offset, T_{b}, from the beginning of the music. The interval between beats can be constant or variable: while much music has a constant beat, some music (e.g., syncopated music) has variable beat spacing.

Music can be evaluated to identify other types of metadata. For example, music can be evaluated to determine the tempo of the music and how the tempo (if at all) changes throughout the music. Music can also be evaluated to identify a mood of the music and how (if at all) the mood changes throughout the music. The evaluation of music to determine the tempo or the mood can be accomplished using methods known to those skilled in the art, see, e.g., the above-referenced Scheirer paper.

Other types of audio content data can be evaluated to determine other types of audio metadata. For example, when the audio content includes a spoken narrative (entirely or in part), the narrative can be evaluated to identify pauses in the narration. Pauses can be identified using methods for pause recognition, as known to those skilled in the art. For example, as known to those skilled in the art of speech recognition, a pause can be identified as an audio segment in which no speech is detected. A spoken narrative can also be evaluated to identify a change in subject matter of the narrative. Subject matter changes in speech can be identified using methods known to those skilled in the art. The display of clips in a visual recording summary according to the invention can be controlled in accordance with the occurrence of pauses and/or subject matter changes in a spoken narrative, in a manner similar to that described in more detail above for controlling the display of clips in accordance with the occurrence of beats in music.

The audio content data and associated metadata can be provided in a variety of different ways for use by a visual recording summary creation system according to the invention (which can, for example, be part of a broader system, such as a home theater system or other audiovisual display system). The invention can be implemented so that the audio content data, the audio metadata or both are stored on a portable data storage medium or media (which can also store the visual recording data and/or visual image metadata), such as one or more DVDs or CDs, which can be inserted into an appropriate data reading device to enable access to the audio content data and/or metadata by the visual recording summary creation system or a system of which the visual recording summary creation system is part. The invention can also be implemented so that the visual recording summary creation system or a system of which the visual recording summary creation system is part enables connection to a network, such as the Internet or a local area network (LAN), to enable acquisition of the audio content data, the audio metadata or both from another site on the network at which that data is stored. The invention can also be implemented so that the audio content data, the audio metadata or both are stored on a data storage medium or media (e.g., hard drive) included as part of the visual recording summary creation system or a system of which the visual recording summary creation system is part. The audio content data and audio metadata can be provided to the visual recording summary creation system together or separately. Additionally, the invention can be implemented so that only the audio content data is provided to the visual recording summary creation system, which then evaluates the audio content data to produce the audio metadata. Some examples of how audio content data and associated metadata can be provided for use by a visual recording summary creation system according to the invention are described in more detail below.

For example, the audio content data and associated metadata can be stored on a portable data storage medium or media (e.g., one or more DVDs or CDs) together with the visual recording data. A user can cause the audio content data and associated metadata to be stored on DVD(s) or CD(s) when using software program(s) and a DVD or CD burner to create the DVD(s) or CD(s). Or, when a commercial service (such as that provided by YesVideo, Inc. of Santa Clara, Calif.) digitizes analog visual recording data and stores the digital visual recording data on a DVD or CD, a user can request that audio content (e.g., music) be stored on the DVD or CD together with the digital visual image data.

A visual recording summary creation system or a system (e.g., home theater system) of which the visual recording summary creation system is part can include a hard drive and an audio CD reader (most DVD players, for example, can also read audio CDs). The system can also include software for creating audio metadata. In such case, the audio content data can be stored on a CD (or other portable data storage medium from which data can be accessed by the system). The user inserts the audio CD into the audio CD reader and the audio content data is transferred to the hard drive, either automatically or in response to a user instruction. As or after the audio content data is transferred to the hard drive, the metadata creation software evaluates the audio content data and produces the audio metadata. The system can also be implemented to enable (and prompt for) user input of some metadata (e.g., titles for musical content, such as album and song titles).

Many music CDs contain information that uniquely identifies the album and each song. The acquisition of audio content data and associated metadata described above can be modified to enable acquisition of metadata via a network over which the system can communicate with other network sites. The metadata for popular albums and songs can be pre-generated and stored at a known site on the network. The system can use the identifying information for musical content on a CD to acquire associated metadata stored at the network site at which audio metadata is stored.

FIG. 4 is a flow chart of a method 400, according to yet another embodiment of the invention, for creating a summary of a visual recording. The visual recording summary produced by the method 400 is accompanied by music. However, the method 400 can be modified to create a visual recording summary accompanied by other types of audio content, as can readily be understood in view of the description elsewhere herein.

In step 401, music is chosen and associated music metadata is retrieved or automatically generated. The choice of music can be based on matching between the music metadata and the visual recording metadata, e.g., the pace or mood of the music as indicated by the music metadata (e.g., beat frequency) can be matched to the content of the visual recording as indicated by the visual image metadata (e.g., the amount of motion. The duration of the visual recording summary, T, can be established, for example, as the duration of the music. The music metadata can include the timing of beats, measures and phrases, and can identify the number of specified beats, B, in the music, as well as the time interval, Ti, for each of specified beats. The time interval, Tᵢ, for each specified beat (which can also be referred to as the beat interval for that beat) is used to determine the duration of a corresponding clip to be included in the visual recording summary. As indicated above, a typical beat interval, Tᵢ, is between about 3 seconds to about 7 seconds. For fast songs (i.e., songs in which a typical beat interval in the song is a fraction of a desired typical duration of clips in the visual recording summary), a minimum clip duration can be enforced, which may necessitate that the duration of a clip be an integer multiple of a corresponding beat interval or a sum of successive beat intervals. For slow songs (i.e., songs in which a typical beat interval in the song is a multiple of the desired typical duration of clips in the visual recording summary), a maximum clip duration can be enforced, which may necessitate that beat intervals of greater than that duration be divided into sub-beats for which corresponding clips are selected.

In step 402, candidate visual images are identified. The candidate visual images can be identified as described above with respect to FIG. 2. In a particular embodiment of the method 400, the candidate visual images are identified using a method as described in the above-referenced U.S. patent application Ser. No. 10/198,602. The total number of candidate visual images, A, is also determined in this step. The total number of candidate visual images, A, can be specified by a user or as a predetermined parameter in the method 400. In the method 400, the number of candidate visual images, A, that are identified is greater than the number of specified beats, B; in one embodiment, the number of candidate visual images, A, is an integer multiple of the number of specified beats, B.

In step 403, the location of scene breaks is determined, either by performing a scene break detection method or by accessing data representing previously identified scene breaks. The beginning and ending locations of scenes in the visual recording are identified using the scene break information.

In step 404 (which is optional), the candidate visual images can be sorted in accordance with one or more criteria. (Even if the step 404 is not performed, the candidate visual images are still arranged in some order in a list.) For example, the candidate visual images can be sorted into chronological order if not already in chronological order. Or, for example, the candidate visual images can be sorted into order according to quality, i.e., highest quality to lowest or vice versa. The way in which the candidate visual images are sorted can affect the manner in which candidate visual images are considered for inclusion in the visual recording summary (step 405, discussed below). In the description of the step 405 below, candidate visual images are considered for inclusion in the visual recording summary with the candidate visual images arranged in chronological order.

In step 405, a selected visual image is determined for the next successive beat interval, Tᵢ. (At the beginning of the method 400, a selected visual image is determined for the first beat interval, T₁, in the music.) The selected visual image is identified from a set of candidate visual images. The set of candidate visual images for each beat interval, Tᵢ, is determined by identifying the next A/B (rounded or truncated to an integer value) candidate visual images in the list of candidate visual images that have not yet been part of a set of candidate visual images. (At the beginning of the method 400, the first set of candidate visual images is populated with the first candidate visual images in the list of candidate visual images.) The selected visual image can be identified from the set of candidate visual images using any of the techniques described above with respect to FIG. 2. In a particular embodiment of the method 400, the selected visual image is identified as the candidate visual image that is contained in a scene having a duration greater than or equal to the beat interval, T₁, that has the highest quality among such candidate visual images.

In step 406, the position, S, of a pointer in the list of candidate visual images is adjusted as needed to keep the ratio S/A (i.e., the percentage progression through the list of candidate visual images) roughly equal to the ratio Sum(Tᵢ)/T (i.e., the percentage of the total duration of the visual recording summary for which clips have been identified). Steps 405 and 406 are successively repeated until a selected visual image has been identified for each beat interval, Tᵢ.

In step 407, an edit list is created for each beat interval, T₁, and corresponding selected visual image. The edit list defines the images comprising a clip that includes the selected visual image. For each clip, the edit list can include an identification (e.g., frame number) of the beginning and ending visual images of the clip. The clip is established so that the duration of the clip is equal to the beat interval, Tᵢ. In a particular embodiment of the method 400, the clip for each beat interval, Tᵢ, is the segment of the visual recording of duration Tᵢ that is centered on the selected visual image for the beat interval, T₁. If the clip determined in this manner traverses a scene break, then the clip is adjusted so that the clip does not cross the scene boundary. (In general, each clip can be adjusted to not cross a scene boundary because each selected visual image must be contained in a scene having a duration greater than or equal to the beat interval, Tᵢ; see step 405, described above. However, if there are clips for which the selected visual image is in a scene that has less than the minimum duration, Tᵢ, the clip can include more than one scene.) In step 408, a display of the visual recording summary is produced from the edit list. If the visual recording is in a compressed format (e.g., the MPEG format), then appropriate apparatus (e.g., an MPEG transcoder) is used to decompress the visual recording data for use in producing the visual recording summary.

In step 409, the music is synchronized with the display of the visual recording summary, using techniques known to those skilled in the art. If deemed desirable, the music can be faded out as the end of the visual recording summary approaches.

Above, aspects of creation of a summary of a visual recording in accordance with the invention are discussed. According to another aspect of the invention, multiple visual recording summaries can be created from a single visual recording. In general, the visual recording summaries can be created in any way. For example, each of the visual recording summaries can be created in accordance with the description above regarding creation of a visual recording summary in accordance with the invention. In particular, this aspect of the invention can be implemented so that a majority of the segments in a first summary of the visual recording are not in a second summary of the visual recording. This aspect of the invention can also be implemented so that each of the multiple visual recording summaries include segments that are not included in any of the other visual recording summaries, i.e., none of the multiple visual recording summaries overlap with another of the visual recording summaries. (For convenience, visual recording summaries that share no segments are sometimes referred to herein as “non-overlapping visual recording summaries.” Visual recording summaries in which a majority of the segments of one of the visual recording summaries are not in the other visual recording summary can be referred to as “substantially non-overlapping visual recording summaries.”) Additionally, further in accordance with this aspect of the invention, non-overlapping visual recording summaries or substantially non-overlapping visual recording summaries can be created from the same set of multiple visual recordings. Any of the aspects of the invention, as described elsewhere herein, can be used to create non-overlapping visual recording summaries or substantially non-overlapping visual recording summaries from the same visual recording or visual recordings.

According to still another aspect of the invention, a visual recording summary can be created from multiple visual recordings. In general, the visual recording summary can be created in any way from multiple visual recordings. For example, the visual recording summary can be created using the content of multiple visual recordings in accordance with the description above regarding creation of a visual recording summary in accordance with the invention from the content of single visual recording. In general, a visual recording summary can be created from any number of visual recordings. The visual recordings from which a visual recording summary is produced can include any content; further, the content of the visual recordings need not necessarily be related. However, it is anticipated that this aspect of the invention will often be implemented in situations in which a visual recording summary is to be produced from visual recordings which include content that is related. For example, this aspect of the invention can be used to produce a visual recording summary from multiple visual recordings of the same event or object (e.g., a sporting event, a family reunion, a party, etc.) that are acquired at the same or approximately the same time, but that are acquired using different visual recording apparatus (e.g., different video cameras) and/or from different perspectives.

According to still another aspect of the invention, a visual recording summary can be created by including one or more still visual images in the summary together with one or more clips. The still visual images can be of any type, such as, for example, digital photographs, Powerpoint slides and/or animated drawings. The still visual images can be selected from a collection of still visual images. Any appropriate method for selecting the still visual images can be used. For example, the methods described above for selecting visual images to use in selecting clips for a visual recording summary according to the invention can also be used to select still visual images from a collection of still visual images for use in a visual recording summary according to the invention. Likewise, the duration of display of each still visual image can be determined using methods described above for determining the duration of display of a clip. Additionally, selection of still visual images from a collection of images and establishing the duration of display of still visual images in a visual recording summary according to the invention can be accomplished using methods described in the above-referenced U.S. patent application Ser. No. 10/226,668.

The capability of producing a display of a visual recording summary in accordance with the invention can be provided to a user in a variety of ways. For example, a visual recording summary or summaries can be created as described above and stored on a data storage medium or media that is made accessible to the user. In particular, the visual recording summar(ies) can be stored on a portable data storage medium or media, such as one or more DVDs or CDs, that are provided to the user. The visual recording summar(ies) can also be stored at a site on a network which a user can access to obtain the visual recording summar(ies). Or, the visual recording summar(ies) can be provided to the user via a network, e.g., electronically mailed to the user. The visual recording summar(ies) can be provided in multiple resolutions. The original visual recording or visual recordings from which the visual summar(ies) are created, metadata regarding the visual recording(s) and/or computer program(s) that enable creation of visual recording summar(ies) from visual recording(s) can also be provided to the user together with the visual recording summar(ies) as described above, e.g., stored together with the visual recording summar(ies) on portable data storage medi(a) (e.g., one or more DVDs or CDs) that are provided to the user, stored at a network site which a user can access, or provided to the user via a network (, e.g., electronically mailed to the user).

Alternatively, metadata that can be used to create a visual recording summary is produced regarding one or more visual recordings from which a user desires to create one or more visual recording summar(ies), as well as, if applicable, non-source audio content that is to be used to accompany the visual recording summar(ies). Some or all of the metadata can be produced during acquisition of the visual recording(s) (or during processing of the visual recording(s), such as digitization, if applicable) or after acquisition (and, if applicable, digitization) of the visual recording(s). The metadata can include, for example, indices that identify clips in visual recording(s) to be included in visual recording summar(ies). Or, the metadata can include, for example, data regarding scene breaks, characteristic(s) of visual images and/or beats in music that can be used to select clips from visual recording(s) for inclusion in visual recording summar(ies). The metadata can be stored together with the visual recording(s) on data storage medi(a) that are made accessible to the user, such as one or more DVDs or CDs that are provided to the user. Or, the metadata can be stored at a site on a network which a user can access to obtain the metadata. Or, the metadata can be provided to the user via a network, e.g., electronically mailed to the user. In the latter two cases, the visual recording(s) can be provided to the user (if not already in the user's possession) by, for example, also making the visual recording(s) available at the network site or sending the visual recording(s) to the user via the network (e.g., by electronic mail), or by storing the visual recording(s) on portable data storage medi(a) (e.g., one or more DVDs or CDs) that are provided to the user. Apparatus and/or computer program(s) that enable creation of a visual recording summary using the provided metadata can already be possessed by the user. Or, if only appropriate apparatus is already possessed by the user, the computer program(s) that enable creation of a visual recording summary can be made available to the user, e.g., the computer program(s) can be stored together with the metadata and visual recording(s) on data storage medi(a) that are made accessible to the user, such as one or more DVDs or CDs that are provided to the user, or the computer program(s) can be made available via a network, either by making the computer program(s) available at a network site or by e-mailing the computer program(s) to the user. The computer program(s) for enabling creation of a visual recording summary can be implemented to enable the user to specify attributes of a visual recording summary, such as, for example, the duration of the visual recording summary, non-source audio content to be included with the visual recording summary, the duration of one or more clips (as well as, if applicable, the duration of display of one or more still visual images), the order of display of clips (and, if applicable, still visual images), and the transition style between a pair of clips (or, if applicable, between a clip and still visual image or two still visual images).

Instead of providing either visual recording summar(ies) or metadata to a user, the user can be provided computer program(s) that enable creation of one or more visual recording summaries from one or more visual recordings. For example, the computer program(s) can be provided to the user on a portable data storage medium or media, such as one or more DVDs or CDs. Or, for example, the computer program(s) can be made accessible via a network, such as the Internet. Or, the computer program(s) can be provided together with apparatus that enables, when operating in accordance with the computer program(s), creation of visual recording summar(ies) from visual recording(s). For instance, a DVD or CD player can be implemented to enable operation in accordance with such computer program(s) (which can be embodied in software or firmware pre-loaded on the player) to create visual recording summar(ies). The computer program(s) can enable all functions necessary or desirable for creation of a visual recording summary in accordance with the invention, including digitization of an analog visual recording, production of metadata from a visual recording (and, if applicable, from non-source audio content), and creation of a visual recording summary using the metadata. The computer program(s) can also enable the user to specify attributes of a visual recording summary (duration of the visual recording summary, transition styles, etc.), as discussed above.

The invention can be implemented, in whole or in part, by one or more computer programs and/or data structures, or as part of one or more computer programs and/or data structure(s), including instruction(s) and/or data for accomplishing the functions of the invention. The one or more computer programs and/or data structures can be implemented using software and/or firmware that is stored and operates on appropriate hardware (e.g., processor, memory). For example, such computer program(s) and/or data structure(s) can include instruction(s) and/or data, depending on the embodiment of the invention, for, among other things, digitizing content data, evaluating content data to produce metadata, selecting clips (and, if applicable, still visual images) for inclusion in a visual recording summary and/or producing a specified transition between clips (and, if applicable, between a clip and a still visual image or between two still visual images). Those skilled in the art can readily implement the invention using one or more computer program(s) and/or data structure(s) in view of the description herein. Further, those skilled in the art can readily appreciate how to implement such computer program(s) and/or data structure(s) to enable execution on any of a variety of computational devices and/or using any of a variety of computational platforms.

Various embodiments of the invention have been described. The descriptions are intended to be illustrative, not limitative. Thus, it will be apparent to one skilled in the art that certain modifications may be made to the invention as described herein without departing from the scope of the claims set out below.

We claim:

1. A method for creating a summary of a visual recording, comprising the steps of:
evaluating the visual recording data of the visual recording; and
selecting one or more segments of the visual recording to be included in the summary of the visual recording, based on the evaluation of the visual recording data, wherein the selected segments of the visual recording comprise less than all of the visual recording.

2. A method as in claim 1, wherein the step of evaluating comprises the step of evaluating the quality of each of a plurality of visual images of the visual recording.

3. A method as in claim 2, wherein the step of evaluating comprises the step of evaluating the content of each of a plurality of visual images of the visual recording.

4. A method as in claim 3, wherein the step of evaluating comprises the step of evaluating the position in the visual recording of each of a plurality of visual images of the visual recording.

5. A method as in claim 2, wherein the step of evaluating comprises the step of evaluating the position in the visual recording of each of a plurality of visual images of the visual recording.

6. A method as in claim 1, wherein the step of evaluating comprises the step of evaluating the content of each of a plurality of visual images of the visual recording.

7. A method as in claim 1, wherein the step of evaluating comprises the step of evaluating the position in the visual recording of each of a plurality of visual images of the visual recording.

8. A method as in claim 1, wherein:
the step of evaluating comprises the step of identifying scenes in the visual recording; and
the step of selecting comprises the step of selecting one or more scenes to be included in the summary of the visual recording.

9. A method as in claim 8, wherein:
the step of evaluating comprises identifying the location of scenes in the visual recording; and
the step of selecting comprises selecting scenes based on the location of scenes in the visual recording.

10. A method as in claim 8, wherein:
the step of evaluating comprises the steps of:
identifying keyframes for the identified scenes; and
evaluating the keyframes; and
the step of selecting comprises selecting scenes based on the evaluation of the keyframes.

11. A method as in claim 10, wherein the step of identifying keyframes comprises the step of evaluating the location of one or more visual images in each of the scenes.

12. A method as in claim 10, wherein the step of identifying keyframes comprises the step of evaluating the content of one or more visual images in each of the scenes.

13. A method as in claim 10, wherein the step of evaluating the keyframes further comprises the step of evaluating the quality, content and/or position in the visual recording of each keyframe.

14. A method as in claim 8, wherein the step of electing comprises the step of determining whether each scene meets a specified criterion or criteria.

15. A method as in claim 8, wherein the step of selecting comprises the steps of:
determining a score for each scene; and
evaluating the scene scores.

16. A method as in claim 1, wherein:
the step of evaluating comprises the step of identifying candidate visual images in the visual recording; and
the step of selecting comprises the steps of:
selecting one or more of the candidate visual images from the visual recording; and
identifying one or more segments of the visual recording that have a specified relationship to one or more of the selected visual images.

17. A method as in claim 1, wherein the step of evaluating and/or the step of selecting are performed, at least in part, automatically.

18. A method as in claim 1, further comprising the step of evaluating audio content to be included in the summary, wherein the step of selecting comprises the step of selecting the one or more segments of the visual recording based on the evaluation of the visual recording data and the evaluation of the audio content.

19. A method for selecting a segment of a visual recording, comprising the steps of:
evaluating the quality, content and/or position in the visual recording of each of a plurality of visual images of the visual recording;
selecting one or more visual images from the visual recording based on the evaluations of the plurality of visual images; and
identifying a segment of the visual recording that has a specified relationship to the one or more selected visual images.

20. A method as in claim 19, further comprising the steps of:
selecting a plurality of groups of one or more visual images from the visual recording based on the evaluations of the plurality of visual images; and
for each of the selected plurality of groups of one or more visual images, identifying a segment of the visual recording that has a specified relationship to the one or more selected visual images.

21. A method as in claim 19, wherein the step of evaluating, the step of selecting and/or the step of identifying are performed, at least in part, automatically.

22. A method for creating a summary of a visual recording, comprising the steps of:
selecting one or more segments of the visual recording, wherein the selected segment or segments of the visual recording comprise less than all of the visual recording; and
associating audio content with the selected segment or segments of the visual recording, wherein the audio content is not part of the visual recording,
wherein the step of selecting and/or the step of associating are performed, at least in part, automatically.

23. A method for facilitating viewing of a visual recording, comprising the steps of:
selecting one or more segments of the visual recording for viewing as a first summary of the visual recording; and
selecting one or more segments of the visual recording for viewing as a second summary of the visual recording, wherein a majority of the segments in the first summary of the visual recording are not in the second summary of the visual recording.

24. A method as in claim 23, wherein none of the segments in the first summary of the visual recording is the same as a segment in the second summary of the visual recording.

25. A method as in claim 23, wherein the step of selecting one or more segments of the visual recording for viewing as a first summary of the visual recording and/or the step of selecting one or more segments of the visual recording for viewing as a second summary of the visual recording are performed, at least in part, automatically.

26. A method for creating a visual recording summary, comprising the steps of:
selecting one or more segments of a first visual recording to be included in the visual recording summary; and
selecting one or more segments of a second visual recording to be included in the visual recording summary.

27. A method as in claim 26, wherein the first and second visual recordings are of the same event or object and are acquired at the same or approximately the same time, but are acquired using different visual recording apparatus and/or from different perspectives.

28. A method as in claim 26, wherein the step of selecting one or more segments of a first visual recording and/or the step of selecting one or more segments of a second visual recording are performed, at least in part, automatically.

29. A method for facilitating viewing of a visual recording, comprising the steps of:
selecting one or more segments of the visual recording to be included in the visual recording summary; and
including one or more still visual images in the visual recording summary.

30. A method as in claim 29, wherein the step of selecting and/or the step of including are performed, at least in part, automatically.

31. A portable computer readable medium or media for storing instructions and/or data, comprising:
instructions and/or data representing a visual recording; and
instructions and/or data representing a summary of the visual recording.

32. A portable computer readable medium or media as in claim 31, wherein the portable data storage medium or media comprises one or more DVDs.

33. A portable computer readable medium or media as in claim 31, wherein the portable data storage medium or media comprises one or more optical disks.

34. A portable computer readable medium or media as in claim 31, further comprising instructions and/or data representing audio content that is not part of the visual recording.
